(19) United States
(12) Patent Application Publication
(10) Pub. No.: US 2016/0258187 A1
(43) Pub. Date: Sep. 8, 2016

(54) COMBINATION LOCK

(71) Applicant: DG INTERNATIONAL HOLDINGS LIMITED, London (GB)

(72) Inventor: Simon Little, Enfield (GB)

(21) Appl. No.: 15/027,487

(22) PCT Filed: Oct. 7, 2014
(86) PCT No.: PCT/GB2014/053019

§ 371 Date: Apr. 6, 2016

(30) Foreign Application Priority Data
Oct. 10, 2013 (GB) 1317969.2
Apr. 16, 2014 (GB) 1406877.9

(51) Int. Cl. E05B 37/00; E05B 37/02; E05B 35/10

(52) U.S. Cl. CPC E05B 37/0072; E05B 35/105; E05B 37/025; E05B 37/0034; E05B 37/0048

(57) ABSTRACT

A combination lock (10) comprising a body (20), a locking mechanism (80), a locking member (30) that is selectively lockable by the locking mechanism, and a combination display face (50) for displaying a variable combination code; wherein the locking mechanism (80) comprises at least one input selector, the or each input selector comprising a plurality of code component array members (40) that can be interacted with by a user to select for each code component array member (40) thereof a code component from a plurality of possible code component options such that a code combination can be selected and such that the selected code can be displayed at the combination display face (50); and associated methods of operation.

The present invention relates to a combination lock such as a padlock.

Combination locks enable a user to secure and unsecure the lock using a memorised code, which is set using components of the lock. This allows users to dispense with having to carry around a separate key for the padlock or multiple keys for multiple locks, be they padlocks, gate locks, suitcase locks, bolt locks, door locks or other locks. These keys are burdensome as they add to the ever-increasing number of items which people have to carry around in their pockets or bags. Additionally, keys can often become lost or even broken, resulting in a lock which cannot be undone. At best, this results in a lock that is useless; at worst, the lock is useless and also needs to be cut open to release whatever it was securing.

Combination locks rely on the user memorising a set code, or input. Traditionally, the code is in the form of 4 numbers. See, for example, GB2498242. However, depending on the size and security required, the code may include more or fewer digits. This code is then input into the padlock, normally through the use of a series of numbered dials. Once the correct code is aligned along a specified location, the locking member is free to disengage.

Modern-day life requires people to remember a large number of codes (for example home security codes, credit/debit card pin codes, mobile phone unlock codes etc). It is generally accepted that while it is easier, it is not as safe to have all codes set as the same combination. Additionally, most codes will require a different number of inputs, and may require a certain combination of numbers and letters, and so using a single code for all of one's devices is not possible. Users, therefore, are often required to remember a large number of different codes. The difficulty in remembering all of these codes is increased by their frequent arbitrariness and the lack of any context which, up until now, has been seen as necessary to provide security. As such, due to the user lacking any sort of mental prompt or association to aid their memorisation of the code, they are often forgotten. Much like losing a key, this results in the lock or padlock being unusable.

An additional problem with many previous designs of combination padlock is that the code is often easily changed by accident. The code must be capable of being changed in order for the user to pick one they hope to remember. This requires a ‘setting’ state, where the user is able to choose their desired code and set the mechanism to lock when this code is entered. Traditionally, in an attempt to make it easy for people to reset the code when the lock is first bought, the setting state is easily entered—by unlocking the lock and opening it, the code becomes changeable. However, this presents a risk that the code is changed accidentally, for example if the user is not paying attention. This can be exacerbated since there is typically little to no visual indication provided to inform the user that the padlock is in the set state.

The combination of the above factors results in the unlock code often being changed to a code the user is not aware of by accident, again resulting in the user being unable to unlock the padlock and the padlock becoming useless.

The present invention seeks to provide a combination lock suitable for a wide range of uses which provides potential for memorable combinations without sacrificing security, or which has a more secure, but still easily achieved, code setting mode, or which has a prominent indication of the setting mode condition.

The present disclosure relates to locks, and in particular combination locks. It is clear that aspects of the present invention are equally applicable to any type of combination lock.

According to a first aspect of the present invention there is provided a combination lock comprising: a body, a locking mechanism, a locking member that is selectively lockable by the locking mechanism, and a combination display face for displaying a variable combination code; wherein the locking mechanism comprises at least one input selector, the or each input selector comprising a plurality of code component array members that can be interacted with by a user to select for each code component array member thereof a code component from a plurality of possible code component options such that a code combination can be selected and such that the selected code can be displayed at the combination display face; wherein the at least one input selector comprises at least one code component array member defining as its code component options a plurality of selectable numbers and at least one code component array member defining as its code component options a plurality of selectable letters.

According to a second aspect of the present invention there is provided a combination lock comprising: a body, a locking mechanism, a locking member that is selectively lockable by the locking mechanism, and a combination display face for displaying a variable combination code; wherein the locking mechanism comprises at least one input selector, the or each input selector comprising a plurality of code component array members that can be interacted with by a user to select for each code component array member thereof a code component from a plurality of possible code component options such that a code combination can be selected and such that the selected code can be displayed at the combination display face; wherein the at least one input selector comprises at least two code component array members that respectively define a different number of code component options.

This second aspect can be in accordance with the first aspect such that at least one of the code component array members defines as its code component options a plurality of selectable numbers and at least one other of the code component array members defines as its code component options a plurality of selectable letters.

For each aspect, preferably one or more code component array member has exactly four options, —e.g. 0, 1, 2 or 3. This can then be a first number of a date (which date may be any number from 01 to 31).

Preferably one, two or three, or more, code component array member has exactly 10 options, —e.g. any of numbers 0 to 9. This can then be a second number of a date (which date may be any number from 01 to 31) or either number of a two-figure year (e.g. 00 to 99), or even any of a 4 digit year (e.g. 0000 to 9999).

Preferably one or more code component array member has exactly 3 options, —e.g. any of numbers 0 to 2. This can then be a first number of a 4 digit year (e.g. 0000 to 2999).

Preferably one or more code component array member has exactly 7 options, —e.g. any of the days of the week (Monday through Sunday).

Preferably for each aspect the display face is arranged for displaying the variable combination code in a date format. Preferably the date format comprises a day section, e.g. a number between 1 and 31 and a month section, e.g. letters indicating the respective months, e.g. JAN, FEB, MAR, etc. Other languages may instead be used, e.g. JAN, FEV, MAR, etc. Preferably there is also a year section, e.g. 00 to 99. These sections can each be formed of a single code component array member, or by multiple code component array members, and preferably the month section is a single code component array member whereas the date and year sections are preferably each formed from two code component array members. The year might even be made of four code component array members for an added number of possible combinations. Further the code may include a day of the week.

Preferably it includes a date, a month and a year, and preferably they are in that order, e.g. for the UK market. Other markets may prefer alternative formats, for example the US may prefer the order to be month, date and then year, and other markets may want the year first.

The letters need not be days of the week or the months—they may be other letter combinations, e.g. individual letters. They may even be symbols, letter forms, words or number forms from other writing systems. They may even be images, or part of an image. For example a number of different code components may be combined to form an image or pattern across the combination display face.

Preferably the code component array members are wheels or dials for rotation to select a selected code for display on the combination display face.

The padlock may additionally feature a key-lock mechanism e.g. for unlocking the padlock when the correct code for releasing the padlock is not known. This is beneficial for TSA applications—e.g. at international borders. Suitable locking member release mechanisms for this purpose are known for example from GB2498242.

Standard padlock designs usually require a body and a locking member, and many such shapes and designs are known in the art. The body of the preferred embodiment of the present invention is generally rectangular or cylindrical, although it can be of almost any conceivable shape, like the prior art padlocks. Preferably, the body is generally cuboid.

As stated above, the body can be of virtually any conceivable shape. As such, the body does not need to form a fully surrounding enclosure and can instead take the form of a casing or housing, for example a casing attached to a flat or curved surface of a secondary object.

The body can define a space between the two components—the body and the secondary object. For example, the body could be a three dimensional casing created by a curved front panel, or a front and sides, being attached to a flat surface; the locking mechanism or locking member being at least partially located behind the front of the panel.

The body may act mainly to secure the position of, or house, the other components of the lock, such as the locking mechanism or locking member.

The body might not only perform the function of being a body for the combination lock, but may also be a part of a further item. For example, the body may be a portion of a further component. For example, for a suitcase combination lock, the body (as termed in the present disclosure) may be part of the suitcase itself. Alternatively, the body may be a part of the handle assembly of the suitcase. For a door lock, the body may be a part of the door.

The locking member generally extends from the body, also like most conventional padlocks, and, when in a locked configuration, forms a loop therewith. It can have a long leg and a short leg, each leg defining an end thereof.

The locking member may, however, not extend from the body. The locking member may be located entirely within the body. The locking member may be actuated, accessed or manipulated through an opening in the body. The locking member may, alternatively, be actuated or manipulated by a handle, lever or other feature protruding through the body. The locking member may be actuated by a biasing means.

In some embodiments the locking member is a shackle. This is preferred for padlocks.

In some embodiments, when the padlock is unlocked, one or both ends of the locking member are released from the body, allowing the item or items to be locked to be located between the locking member and the body. The locking member end or ends are then located back in the receiving section of the body and locked in place to lock the padlock to the item or items.

The body of the lock can be of any size, and is usually chosen based on the intended use of the lock and the sophistication of the locking mechanism. Larger bodies may be able to accommodate larger locking members and more sophisticated locking mechanisms, including anti-tamper devices, hardened steel jackets, and/or secondary or tertiary locking mechanisms or input selectors, thus potentially resulting in higher security. Smaller bodies, however, are better suited to space-limited applications, or where the main function of the lock is to resist casual access to, or use of, an item, i.e. simply for acting as a deterrent, rather than achieving a high degree of security.

The body can be of any form. The body may be a front panel, thus keeping a locking mechanism and locking member between the body and a second surface such as a door panel or suitcase front. The body may simply be a cover, protecting a locking mechanism and locking member from being exposed to the elements.

The body may not be a separate component, but may, in fact, be a further component of the lock (e.g. the locking member) or a part of the item being locked (e.g. the door, suitcase, bolt).

The body may comprise, or be formed to provide, a space defined between a front panel and a surface of an item to be locked. To stand proud of the surface, that panel may be bounded by sides. However, it might be provided as a flush body, i.e. flush with the surrponding components of the product—e.g. on a suitcase or briefcase.

The body may comprise, or be formed of, at least part of the item to be locked.

The body may be a buckle or a part thereof, e.g. part of a suitcase or luggage strap, or part of a sprung closure mechanism.

The body may be a suitcase or briefcase, or a part thereof. It may be for securing one or more zipper, or it may be a panel lock for the suitcase or briefcase, or it may be for securing a sprung closure.

The body may be a shoot-bolt or a part thereof.

The body may be a zipper lock, or a part thereof, for luggage or items other than suitcases or briefcases.

The locking member can be of virtually any form, and is largely dependent on the desired use of the lock. Some uses require a long, thin locking member while others require less length but a larger thickness to reduce the chances of the locking member being cut.

The locking member may be a blocking bar or member that acts to prevent removal of a component from the body, thus locking it in place. The locking member may be a gripping member, retaining a component in a fixed location until the correct code is entered and the lock unlocked.

The locking member might even be a length of chain or wire. However, in most circumstances the locking member will be a solid “U” shaped section of metal, partially constrained within the body in a permanent manner on one side, albeit in a manner that is rotatable when the padlock is unlocked, usually about the axis of that side, and selectively releasable from the body on the other side so as to allow that rotation.

In the preferred embodiments, when in an unlocked state the locking member is generally free a) to rotate about its constrained end, and b) to slide a limited amount into and out of the body.

Preferably, the locking member is a curved metal loop protruding from one face of the body. As stated above, however, the locking member can have many forms while still meeting the requirements of the claims.

The locking member may be located entirely within the body.

The locking member may be a blocking member.

The locking member may be a gripping member.

The body may be part of the locking member.

The locking member may be part of the body.

It should be highlighted that unless stated otherwise, the term code and combination are used interchangeably throughout the present disclosure.

A combination lock requires a user to input a code, which releases at least part of the locking member, allowing it, for example, to slide out and or rotate and release the locked item or items. Alternatively, upon release, at least part of the locking member may withdraw from a blocking position, or release a gripped component.

To facilitate the entering, changing and monitoring of the code, the preferred padlock of the present disclosure comprises a combination display face. This combination display face can be located anywhere on the device, providing the user has visual access to it. Preferably, this display face is located on a flat surface of the body. However, the display face can equally be located on an edge or corner of the body. This is often the case in smaller locks.

The display face may be integral with the body, or flush therewith, for example without there being any clear distinction between the two components. As such, a display face may effectively be, or acually be, the body. Alternatively, the body may be part of a further item, for example a door, suitcase or bolt, in which case the display face may be located on the door, suitcase, bolt or other component comprising the body.

Preferably, the input selectors can be accessed and manipulated at the display face. As such, this acts as the interface between the user and the locking mechanism. The display face is not constrained in terms of size or shape other than by the size of the body and the input selectors of the lock. Preferably, the display face comprises a marking to show the user where or how the correct code has to be aligned or organised for the padlock to unlock.

The input selectors comprise a number of code component array members, each of which has a plurality of possible code component options, or inputs. Each input is generally, but not necessarily, a character. Characters can be numbers, letters or even images. The code component array members may have inputs that are all numbers or that are all letters or that are a mix of numbers and letters, or other characters. Characters can be from any language. An input could even be a blank, i.e. with no character thereon e.g. for displaying “_1” rather than “01”..

Preferably the at least one input selectors have code component array members in the form of rotatable dials, and more typically independently rotatable dials.

Preferably the dials take the form of cylinders or discs.

Preferably the display face is located on one surface of the body, with the rotating dials partially protruding therefrom or partially visible thereat.

Preferably the input selector(s) are arranged inside, or are partially covered by, the body so as to be at least partially exposed at or through the display face.

Preferably the code component arrays are arranged inside, or are partially covered by, the body so as to be at least partially exposed at or through the display face.

Preferably the dials are arranged inside the body so as to have at least one portion of their circumference exposed at or through the display face, with characters marked on the dials around the circumference.

Preferably each input selector provides a plurality of input combinations from which the user has to choose so as to select the correct one for unlocking the padlock. A large factor in the security of a given padlock is the number of potential combinations. This can thus be governed by the number of permutations per code component array member, e.g. the number of inputs on each given dial. Further, the greater the number of dials, the more potential combinations become available, and therefore the better the security of the lock.

Preferably the lock comprises a plurality of code component array members, preferably dials, aligned within the body. Preferably these code component array members are adjacent one-another.

Preferably the code component array members are cylindrical dials that can rotate about an axis running through the centre of the generally cylindrical form that is formed thereby.

Preferably the plurality of dials are aligned collinearly.

Preferably the display face comprises a line—typically a broken but straight line—along which the code component array members' code components/inputs which make up the correct combination need to be aligned to unlock the padlock.

Preferably there are at least two code component array members, and more preferably there are exactly five. More than five input selectors, however, is also anticipated as being within the scope of the present invention.

The locking mechanism is responsible for restraining the locking member when the lock is in a locked state. Preferably the locking mechanism is located in the body of the lock. Alternatively, the locking mechanism may be partially covered by, protected by, or obscured by the body. The locking mechanism may be located between the body and a third component.

The locking mechanism prevents the locking member from being withdrawn from the body, rotated relative to the body, slid relative to the body, or withdrawn from a blocking/gripping position until the correct combination is present in the required location.

The at least one input selector according some embodiments of the present invention is adapted to display a date. While a random string of numbers is hard to memorise, especially with the number of different pin numbers and codes that are required in modern-day life, dates are easier to remember as they are often already associated with a memory or occurrence. As such, a user is able to set the unlock-code of the padlock to a significant date, be that their birthday, their partner's birthday or the date of any other significant event or occasion. This makes the code much easier to remember, but still provides ample security.

Additionally, the user could choose a date which is related to the item that is being locked, to provide a further prompt when trying to remember the combination. For example, when locking up a bike which was a birthday present, the user could set the lock code to the date of the birthday when they received the bike.

A standard 4 dial combination lock has 10×10×10×10=10000 possible combinations. An example of the present embodiment where dates can be selected in the format DD-Month-YY, for example 27-Jan-87, with a 4-option dial for the first number, has 4×10×12×10×10=48000 possible combinations, yet only three combination parts need to be remembered, rather than four (a date a month and a year, rather than four digits), each of which are typically chosen for their familiarity to the user, and which are thus easily remembered. The present invention thus not only provides a product that has a more memorable code/combination, but also provides a more secure code form, even if allowing for the relatively small number of impossible dates (e.g. anything above the 31^{st} of a month), although these still represent usable combinations if desired.

Preferably the lock comprises a single input selector having code component array members for providing the required code. However, the padlock may have separate input selectors for forming the required code. For example, it may have at least three input selectors, one input selector being associated with the day, and thus having two code component array members. The second may be for the month, and thus may have just one code component array member (although for a date in digit form, this might be two, perhaps one having two options and the other having ten, or for letter forms this could even be three or more separate code component array members), and a third may be for the year, thus having perhaps two or four code component array members. However, it is foreseen that a single input selector is preferred. It can have the five code component array members or a different number thereof, e.g. indicating only one or two of the days, months or years, or the days of the week.

The inputs or the display face could have the characters added thereto in their moulding, or as an engraving or an added marking, such as with ink or paint, or an embossment.

Preferably one or a combination of dials is used to indicate a day, month and year respectively. The order that these pieces of information are displayed on the display face is variable for different markets. However, preferred forms are the British arrangement of DD-MM-YY or DD-MM-YYYY (where DD is the day, MM is the month and YY/YYYY is the year) or the American arrangement of MM-DD-YY or MM-DD-YYYY. Other formats, including formats such as that used in Japan of EDD-MM-YYYY where E denotes the era, are also foreseen as being within the scope of the present invention.

Preferably, each code component array member comprises two or more selectable options or characters.

Preferably, the code component array members do not all have the same number of selectable inputs.

Preferably, the day section comprises 2 code component array members, one for the tens column and one for the units column.

Preferably, the code component array member in the tens column comprises exactly 4 inputs: “0”, “1”, “2” and “3”. As the range required when selecting a date is 1 to 31, the code component array member for the tens of days does not need to go past 3. As such, only four inputs are required on this code component array member.

Preferably, the code component array member in the units column comprises 10 inputs: “0” to “9”. The combination of the two dials therefore allows the full required range to be selected.

Preferably, the month section comprises one code component array member, the code component array member comprising 12 inputs, each input comprising the first three letters of a month. This allows a user to select a month, for example October, which will be represented as “OCT”. Naturally, other ways of representing the month are possible. Numbered code component array members could be used, as with those for the date, with the first code component array member comprising only of a “0” and a “1” and the second code component array member comprising the inputs “0” to “9”, or with a single code component array member having the 12 inputs. Alternatively, the month could be represented in letters, with each individual letter either of the first three letters of the month or the entire month name being selectable on separate code component array members. As some months have longer names than others, this may make it appropriate to have some of the code component array members to have blanks as inputs.

Other arrangements are also possible, although increasingly impractical, such as the day section could comprise a series of code component array members with letters on, allowing the user to spell the date, e.g. “EIGHTH”.

Preferably, the year section comprises two code component array members, one for the tens column, and one for the units column. Optionally, the year section may comprise four code component array members, allowing the user to select a millennium and century as well as decade and year.

As such, preferably the day section comprises 2 code component array members, one for the tens column and one for the units column, the code component array member in the tens column comprising 4 inputs: “0”, “1”, “2” and “3”, and the code component array member in the tens column comprises 10 inputs: “0” to “10”, the month section comprises one code component array member, the code component array member comprising 12 inputs, each input comprising the first three letters of a month; and the year section comprises two code component array members, one for the tens column, and one for the units column.

Preferably, the locking mechanism further comprises a code set indicator and when the combination lock is in a code-set state, the indicator is exposed. In a preferred arrangement, it displays a word or symbol to illustrate the code-set state or mode is operative. Preferably the code set indicator displays the word “SET”.

This indicator can have any of the following features, but is additionally a part of a third aspect of the present invention.

According to the third aspect of the present invention there is provided a combination lock comprising: a body, a locking mechanism, a locking member that is selectively lockable by the locking mechanism, and a combination display face for displaying a variable combination code; wherein the locking mechanism comprises at least one input selector, the or each input selector comprising a plurality of code component array members that can be interacted with by a user to select for each code component array member thereof a code component from a plurality of possible code component options such that a code combination can be selected and such that the selected code can be displayed at the combination display face; wherein the combination lock has a code-set state achieved by a movement of the locking member and a code set indicator that will be exposed when the combination lock is in a code-set state, the indicator displaying an image, symbol or word thereon to illustrate and advise that the code-set state is operative,

This third aspect of the invention can also be in accordance with any of the features of the first and second aspects of the invention.

The indicator is provided to notify a user when the lock is in the code-set state. Users of combination locks often find that during transit, use or storage in an unlocked state the code can easily be reset by accident. As the code was not intentionally set to a desired combination, this results in the locks being inoperable if then locked, and thus in effect it becomes useless. The problem often arises from the user being unaware that the lock is in a code-set state, and so actuates the input selectors for whatever reason, unaware that the unlock-combination is being changed as they do so.

The present invention overcomes this problem by including the indicator, clearly informing the user that the lock is in a code-set state. As the user is immediately notified when the lock enters a code-set state, the user is able to either exit this state, or continue and set the combination to the desired code.

Preferably the indicator is generally cylindrical. Alternatively the indicator may be of any shape. Preferably the indicator protrudes from the body. Alternatively the indicator may protrude from the locking member or display face. Alternatively the indicator may not protrude from the surface, but may attract the users attention in some other manner. For example, the indicator may be a sliding member, wherein the sliding member is located in one position when not in the code-set state, but slides to a “SET” state when the lock is put in a code-set state.

Preferably, the indicator protrudes from the opposite side of the body to the locking member, if the locking member protrudes from the body. This is desirable as it is more likely to be noticeable if the indicator is not in the vicinity of the locking member (which is likely to be protruding from the body already). Additionally, if the locking member needs to be depressed to enter the code-set state it is easier, mechanically, to have such an arrangement.

The locking member can be directly or indirectly connected to the indicator, and arranged in a preferred arrangement such that as the locking member is depressed, the indicator is forced, preferably against a biasing means, to extend from the other side of the body. Preferably, however, the indicator is a separate component of the lock compared to the locking member, although they can contact one-another in the preferred arrangement, as discussed above.

Preferably, a biasing means is attached to the indicator, biasing the indicator towards a retracted state.

In a preferred arrangement, when a force of a depressed locking member is removed (i.e. when the lock is no longer in a code-set state), the biasing means actuates the indicator into a non-protruding state.

Preferably the indicator protrudes from the in-use base of the body when the lock is in a code-set state, if the body has a base.

If the body does not have a base, or if the locking member does not protrude from a surface of the body, preferably the indicator protrudes from an exposed surface of the body.

Further, preferably the indicator is pushed to protrude from the body directly or indirectly by the locking member as the locking member is pushed towards the body, or in a direction within the body, to enter a code-set state.

Preferably the indicator is biased into a non-exposed state.

Although a cylinder is preferable, other shapes are foreseen as being able to perform the same function, and as such, any shape indicator is seen to be within the scope of the present invention.

Preferably the indicator comprises the word “SET”. Preferably this word is etched, engraved or embossed in or on the indicator. Most preferably it only becomes visible upon the indicator being deployed into or towards its set-mode indicating position, i.e. it is not visible while the indicator is in a fully non deployed position.

A significant factor in accidental combination changes as described above, is that with many combination locks it is easy to unintentionally enter a lock-setting state. This is often achieved simply by rotating the locking member (when in an unlocked state) through 180 degrees, or by rotating and depressing it. This is often done unintentionally, and regularly results in accidental combination resets.

The present invention avoids this by employing a required sequence of movements to enter the code-setting state. These movements are not difficult to make, meaning the dexterity or strength of the user is irrelevant. However, the movements do require an active decision on the part of the user and, as such, are extremely unlikely to occur by accident.

Preferably, in order to enter a code-setting state, the locking member must be simultaneously pushed towards the body and rotated.

Other series of movements are also foreseen and within the scope of the present invention. Examples include the locking mechanism needing to be pulled and rotated, or pushed and rotated a number of times in sequence.

This sequence or these sequences are also a preferred aspect of the present invention and as such according to a fourth aspect of the present invention there is provided a combination lock comprising: a body, a locking mechanism, a locking member that is selectively lockable by the locking mechanism, and a combination display face for displaying a variable combination code; wherein the locking mechanism comprises at least one input selector, the or each input selector comprising a plurality of code component array members that can be interacted with by a user to select for each code component array member thereof a code component from a plurality of possible code component options such that a code combination can be selected and such that the selected code can be displayed at the combination display face; wherein the combination lock has a code-set state achieved by a movement of the locking member, the movement comprising, after unlocking the lock and extending the locking member a short distance out of the body, a first rotation of the locking member, and then a depression of the locking member and then a further rotation of the locking member while the locking member remains depressed, the further rotation being a rotation beyond the first rotation.

This fourth aspect of the invention can also be in accordance with any of the features of the first, second and third aspects of the invention.

Preferably, the locking member is prevented from being inadvertently pushed towards or pulled away from the body when in an incorrect configuration by the combination of a protrusion in the locking member and two slots on the body, the slots respectfully aligning with the protrusion only to allow the opening of the lock when unlocked and then the depression of the locking member after the required first rotation has been performed. Preferably that first rotation is a rotation through an angle of 90°.

Preferably, the locking member comprises a protrusion, knob, lip or equivalent, and the body comprises a corresponding slot, hole or recess. In order for the locking member to be able to move in a direction towards the body, the protrusion must be aligned with the slot. As such, the locking member must be rotated until the protrusion and slot align, and the locking member can then be depressed into the body by a predetermined amount.

Preferably, the locking member comprises a protrusion and the body comprises at least one slot adjacent the locking member, wherein the protrusion prevents the locking member from being pushed towards the body unless a slot and protrusion are aligned.

Preferably, a slot is located substantially 90 degrees from the protrusion when the lock is in a locked state, so that to enter a code-setting state, the locking member is rotated 90 degrees before being pushed towards the body.

Preferably, once the locking member is moved towards the body, with the protrusion entering the slot, the protrusion is located in an internal channel, thus allowing the locking member to achieve the further rotation, with the protrusion travelling along the internal channel.

Once the locking member is depressed, it is again free to rotate. Once the locking member has been rotated, so that the protrusion and slot are no longer aligned, the locking member will remain in a depressed position without requiring the user to enact a force on the locking member. The locking member will remain in a depressed position relative to the body, until the protrusion and slot are aligned again.

Preferably, to enter a code-setting state, the locking member is rotated a further 90 degrees while pushed towards the body.

Preferably, to enter a code-setting state, the locking member is rotated 90 degrees before being pushed towards the body. In such a preferred embodiment the locking member has to be rotated by 90 degrees before the protrusion and slot are aligned, allowing the locking member to be moved relative to the body.

Preferably, the protrusion will travel the length of the internal channel while the locking member rotates in a depressed position. Once the protrusion abuts the end of the channel, the locking member is no longer able to continue rotating. Preferably, the locking member is unable to rotate further than 90 degrees while depressed. As the locking member is preferably rotated 90 degrees before being moved towards the body, this mean the locking member preferably is unable to rotate further than 180 degrees from the locked position when in a code-setting state.

Preferably the total rotation is about 180°, although other angles can be predefined instead both for the total rotation and for the extent of the first rotation.

Preferably, the combination lock is compliant with Transportation Security Administration (TSA) standards. As such, the lock comprises a TSA compliant key slot, a.k.a. a TSA general access lock, and wherein the lock can be opened without the need for the combination by the corresponding TSA compliant key.

Preferably, the TSA general access lock is on a different face of the body to the display face.

According to a further aspect of the present invention there is provided a combination lock comprising: a body; a locking member; a locking mechanism; and a combination display face; wherein the locking mechanism comprises at least one input selector, the or each input selector comprising a plurality of selectable inputs or code component array members, each having a plurality of code component options thereon, the input selector being arranged to be interacted with by a user for enabling the user to select a code therewith, the code being indicated by selected code component options on the inputs or code component array members, the selected code being displayed on the combination display face, wherein at least one of the inputs or code component array members comprises code component options formed of two or more characters.

A single character is conventional for existing combination locks, i.e. a plurality of selectable individual numbers or letters, with all of the inputs or code component array members of the input selector having the same type of character (i.e. all numbers or all letters). However, by having more than one character in a selectable option, more complex informational strings can be generated, such as the dates of the preferred embodiment.

Preferably there are three characters, e.g. the first three letters of a month or the first three letters of a week day. Other words or character combinations are also possible, e.g. two or three letter words for creating sentence strings.

Preferably, the at least one input selector comprises selectable code component options comprising both numbers and letters. It is also preferred that the display face is suitably arranged for displaying a date, e.g. using those numbers and letters. The most preferred arrangement is where the display face comprises a day section, a month section and a year section.

In a further aspect of the present invention, there is provided a combination lock comprising: a body; a locking member; a locking mechanism; and a combination display face; wherein the locking mechanism comprises at least one input selector, the or each input selector comprising a plurality of selectable inputs or code component array members, each having a plurality of code component options thereon, the input selector being arranged to be interacted with by a user for enabling the user to select a code therewith, the code being indicated by selected code component options on the inputs or code component array members, the selected code being displayed on the combination display face, wherein some or all of the selectable inputs or code component array members do not have the same number of selectable code component options thereon to the others.

In a further aspect of the present invention, there is provided a combination lock comprising: a body; a locking member; a locking mechanism; and a combination display face; wherein the locking mechanism comprises at least one input selector, the or each input selector comprising a plurality of selectable inputs or code component array members, each having a plurality of code component options thereon, the input selector being arranged to be interacted with by a user for enabling the user to select a code therewith, the code being indicated by selected code component options on the inputs or code component array members, the selected code being displayed on the combination display face, wherein when the combination lock is in a code-set state, an indicator is exposed, the indicator displaying thereon a word or symbol to illustrate that the code-set mode is operative.

In a further aspect of the present invention there is provided a combination lock comprising: a body; a locking member; a locking mechanism; and a combination display face; wherein the locking mechanism comprises at least one input selector, the or each input selector comprising a plurality of selectable inputs or code component array members, each having a plurality of code component options thereon, the input selector being arranged to be interacted with by a user for enabling the user to select a code therewith, the code being indicated by selected code component options on the inputs or code component array members, the selected code being displayed on the combination display face, wherein to enter a code-set state, the locking member must be simultaneously pushed towards the body and rotated.

Each of these further aspects of the invention can combine with any of the features of the other aspects of the invention, including the various preferred or optional features discussed above and below.

According to another aspect of the present invention there is provided a method of opening a combination lock, comprising the steps of actuating input selectors of the lock to set a combination code thereon to a certain predefined date and then opening the lock.

According to another aspect of the present invention there is provided a method of setting a new combination for a combination lock, comprising the steps of: entering a predefined combination on the lock using an input selector to unlock the combination lock, moving a then unlocked locking member of the lock away from a body of the lock to allow it to then rotate, then rotating the locking member by a first predetermined amount then depressing the locking member towards the body, and then rotating the locking member by a second predetermined amount relative to the body while it is in a depressed state; and then entering the desired new combination.

Preferably the next step is to rotate the locking member back towards the original position.

Preferably, either or both of the predetermined amounts is substantially 90 degrees.

Preferably, the locking member must be depressed into the locking body with the locking member at a predetermined position relative to the body.

Preferably, the locking member must be depressed into the locking body against a spring bias.

Preferably, the locking member will be biased out of its depressed state so as to spring out as it is rotated back towards the original position—preferably at the first predetermined position (the position where it was depressed towards the body).

The preferred features disclosed in relation to each aspect of this invention apply, mutatis mutandis, to the other aspects of the present invention.

The present invention will now be described, purely by way of example, with reference to the accompanying drawings, in which:

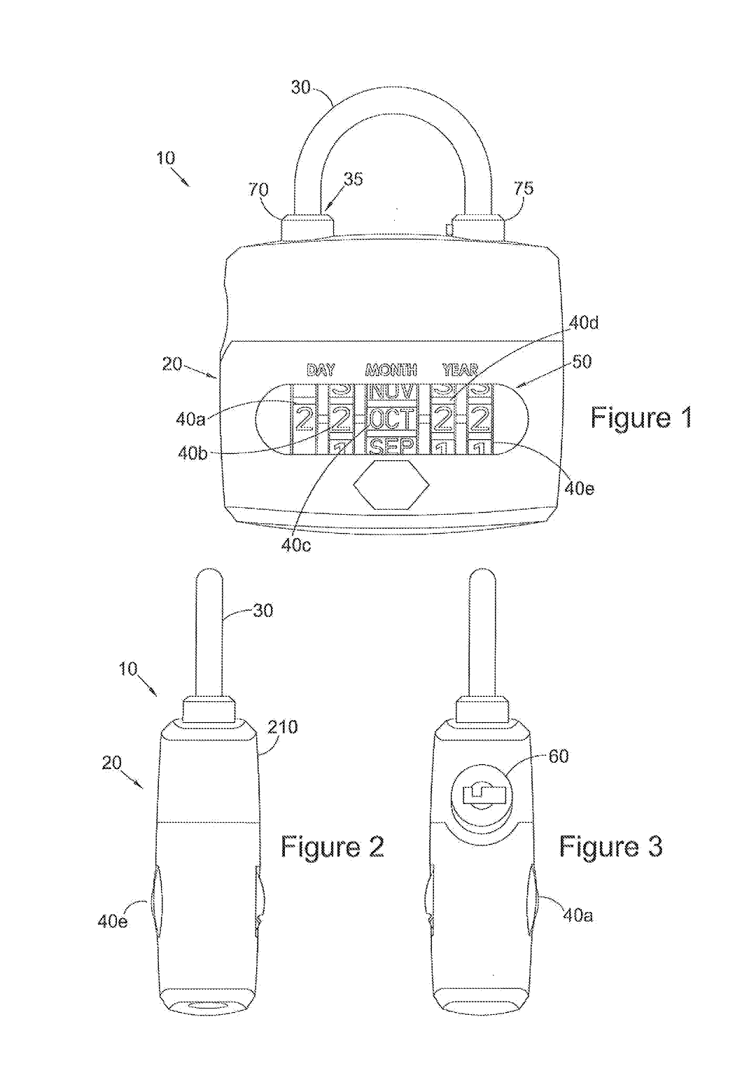

FIG. 1 is a front view of a combination lock according to an embodiment of the present invention, in a closed configuration;

FIG. 2 is a side view of the combination lock of FIG. 1;

FIG. 3 is an opposite side view of the combination lock of FIG. 1;

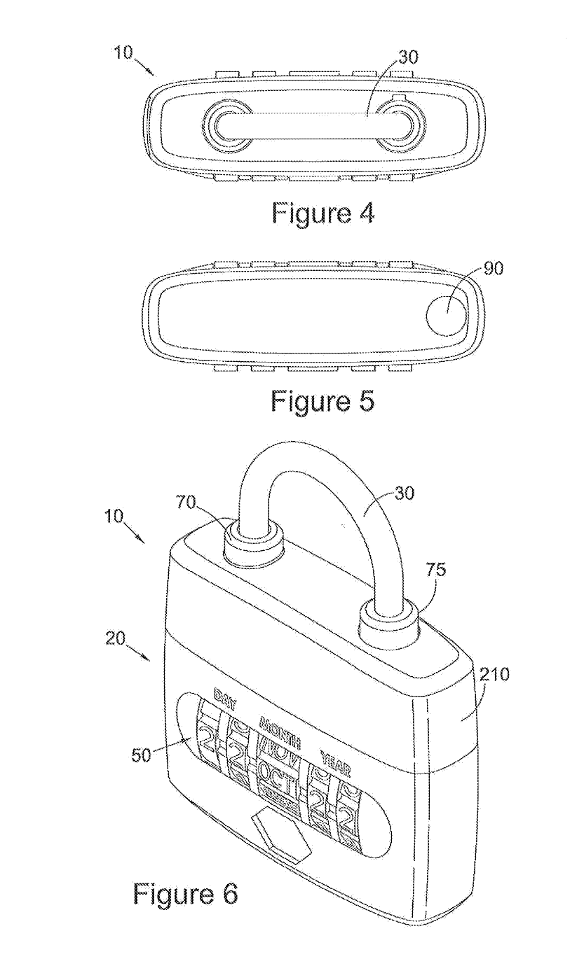

FIG. 4 is a top view of the combination lock of FIG. 1;

FIG. 5 is a bottom view of the combination lock of FIG. 1;

FIG. 6 is a perspective view of the combination lock of FIG. 1;

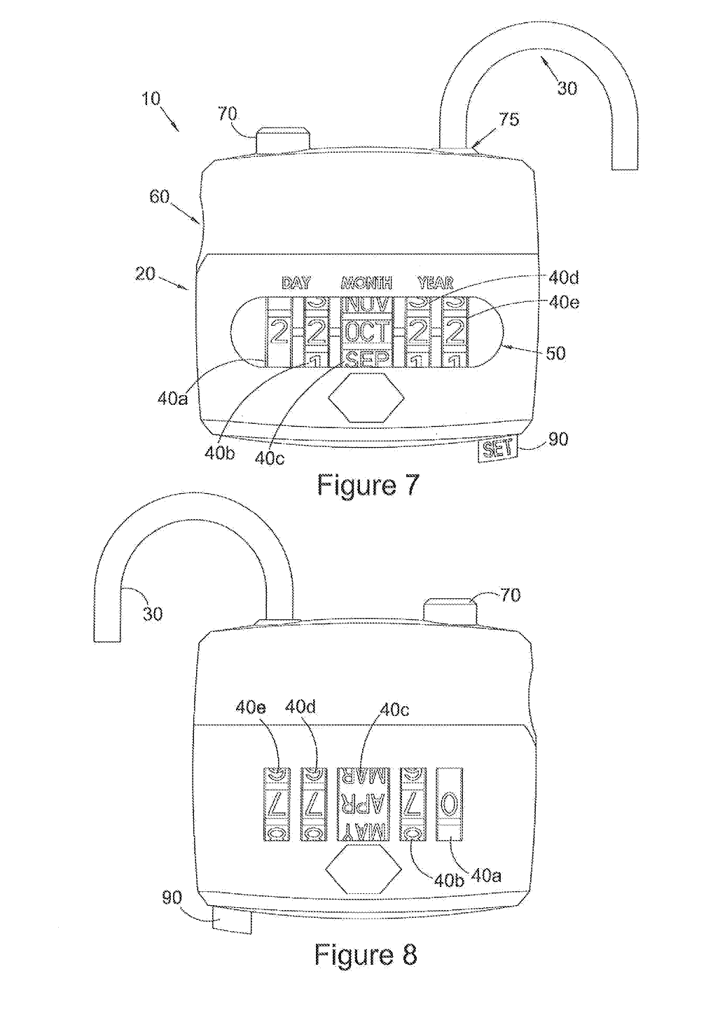

FIG. 7 is a front view of the combination lock of FIG. 1, in a code-set state;

FIG. 8 is a rear view of the combination lock of FIG. 7;

FIG. 9 is a side view of the combination lock of FIG. 7;

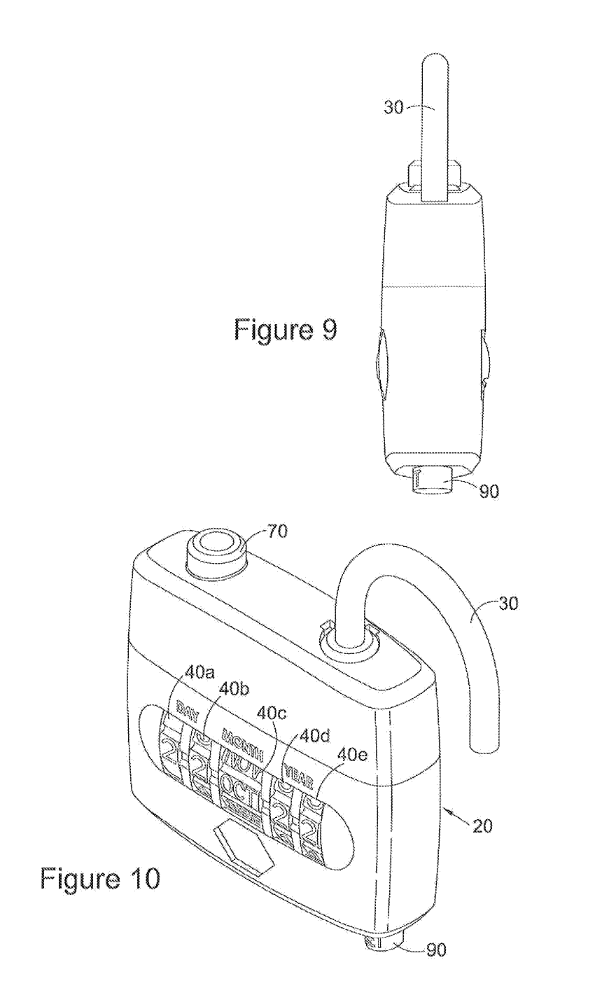

FIG. 10 is a perspective view of the combination lock of FIG. 7;

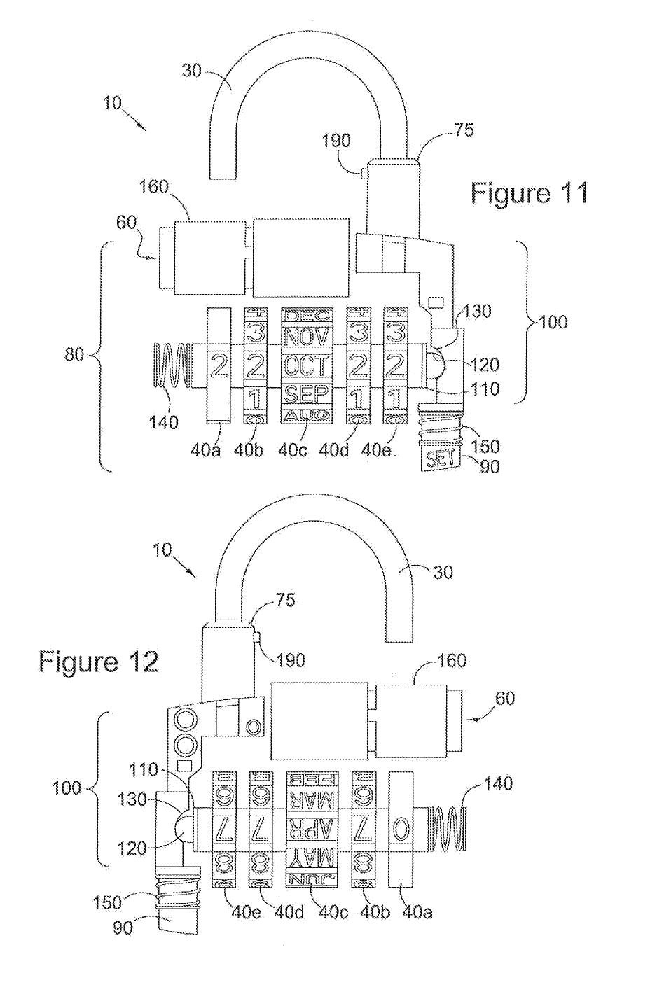

FIG. 11 is a front view of the combination lock of FIG. 1, with the front, rear and top components of a body of the lock removed for showing the main components of the internal working mechanism;

FIG. 12 is a rear view of the combination lock of FIG. 11;

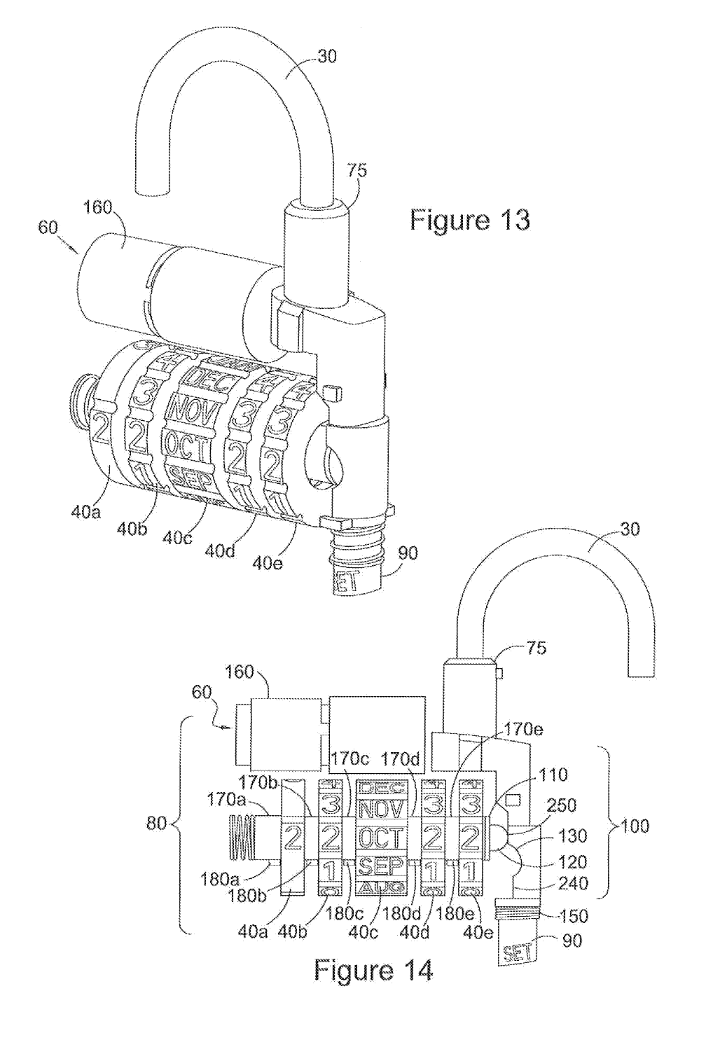

FIG. 13 is a perspective view of the combination lock of FIG. 11;

FIG. 14 is a front view of the combination lock of FIG. 7, with the front, rear and top components of the body of the lock removed for showing the main components of the internal working mechanism in the code-set state;

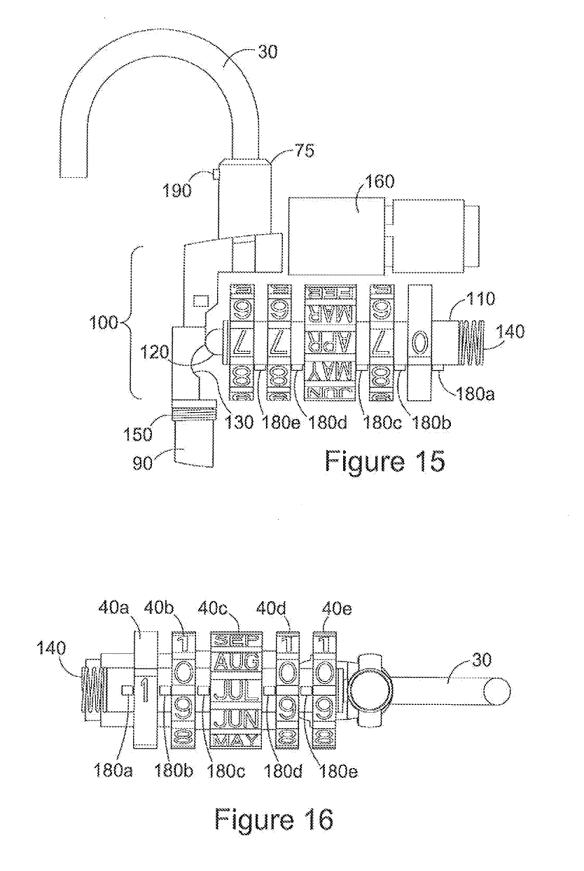

FIG. 15 is a rear view of the combination lock of FIG. 14;

FIG. 16 is a bottom view of the combination lock of FIG. 14;

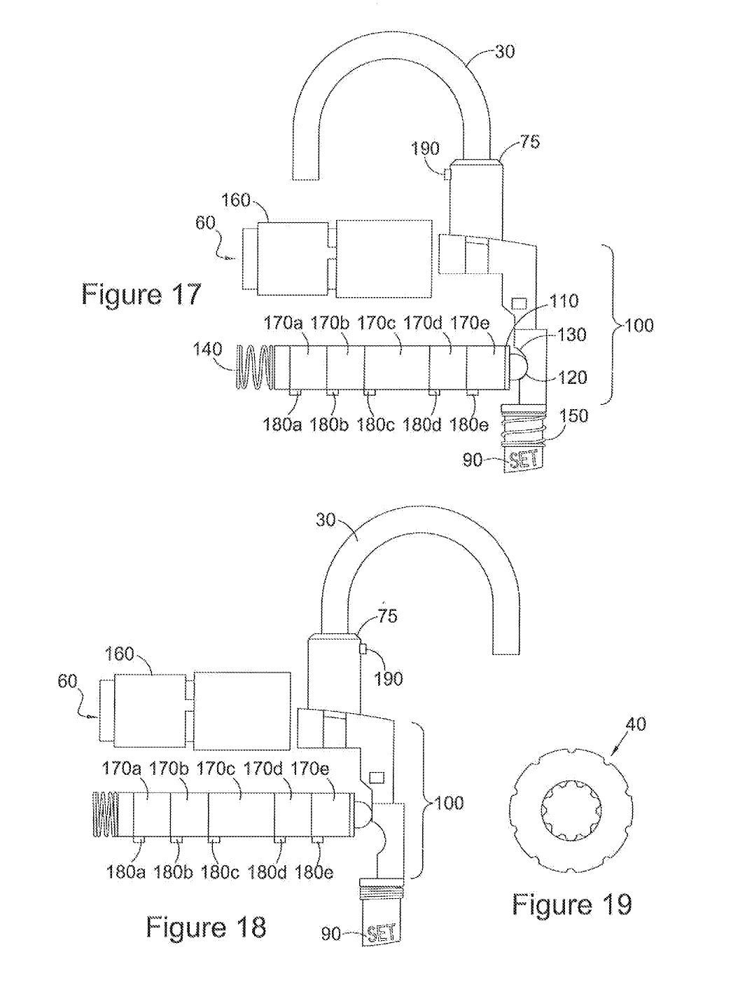

FIG. 17 is a front view of the combination lock of FIG. 11, but with selectable inputs or code component array members of its input selector removed for showing further details of its setting/locking mechanism;

FIG. 18 is a front view of the combination lock of FIG. 14, but with the selectable inputs or code component array members of the input selector removed for showing further details of its setting/locking mechanism in the code-set state;

FIG. 19 is a side view of a selectable input or code component array member of the input selector according to an embodiment of the present invention—for showing internal details thereof;

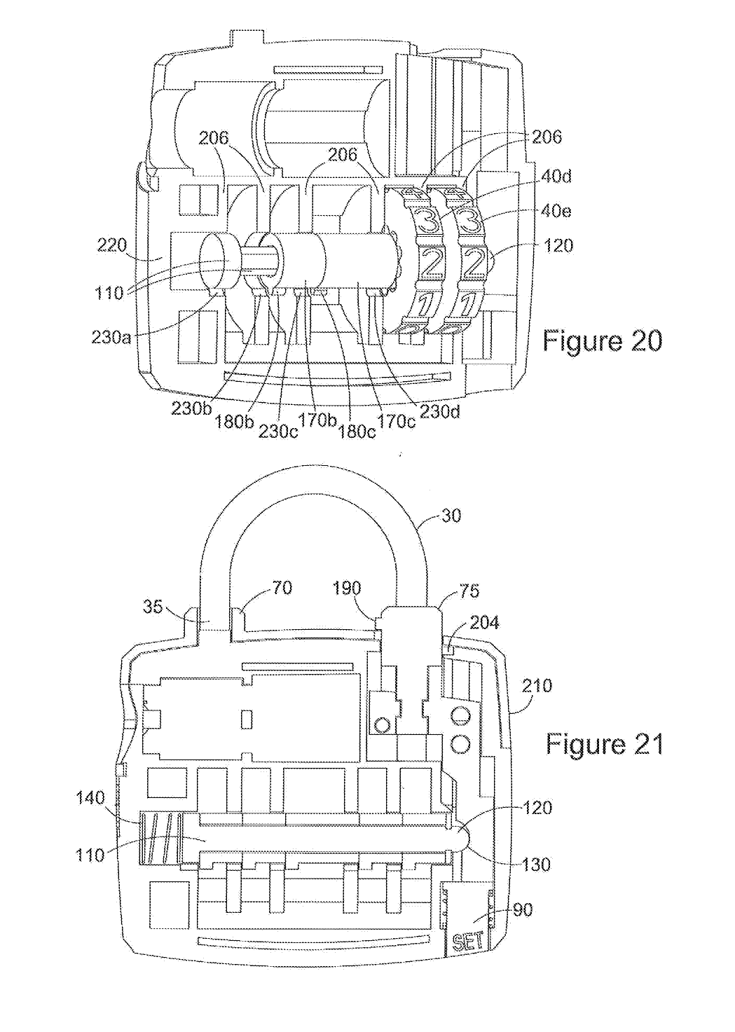

FIG. 20 is a perspective view of the combination lock of FIG. 1 with a front case component and various other components removed, including some of the selectable inputs or code component array members and the locking member, for further illustrating certain details of the internal working mechanism, and their positional relationship relative to the body of the lock;

FIG. 21 is a front view of the combination lock of FIG. 1, with the front and top casing removed, for further illustrating certain details of the internal working mechanism, and their positional relationship relative to the body of the lock;

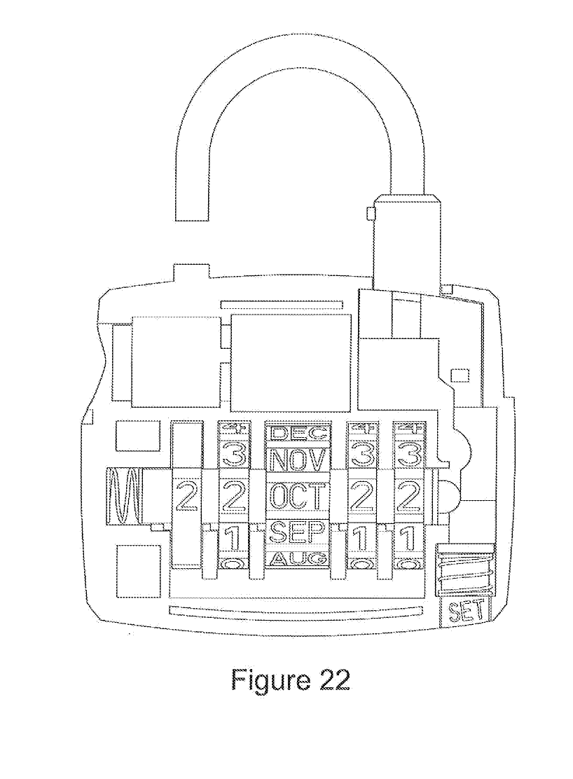

FIG. 22 is a front view of the combination lock of FIG. 1, with the front and top casing removed, but with the locking member pulled outward relative to the body of the lock for opening the lock;

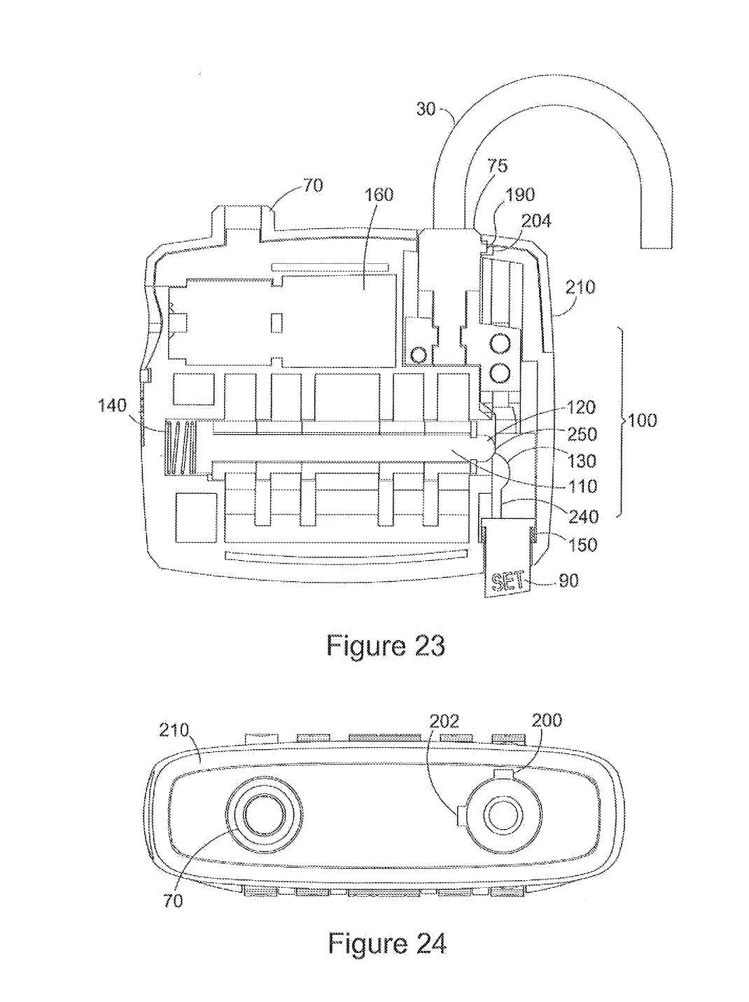

FIG. 23 is a front view of the combination lock of FIG. 7, with the front and top casing removed—with the locking member, from the intermediary state of FIG. 22, having been rotated and then pushed inward and then further rotated into the code-set state;

FIG. 24 is a top view of the combination lock of FIG. 1, but with the locking member removed to illustrate guide-slots for the above two rotations;

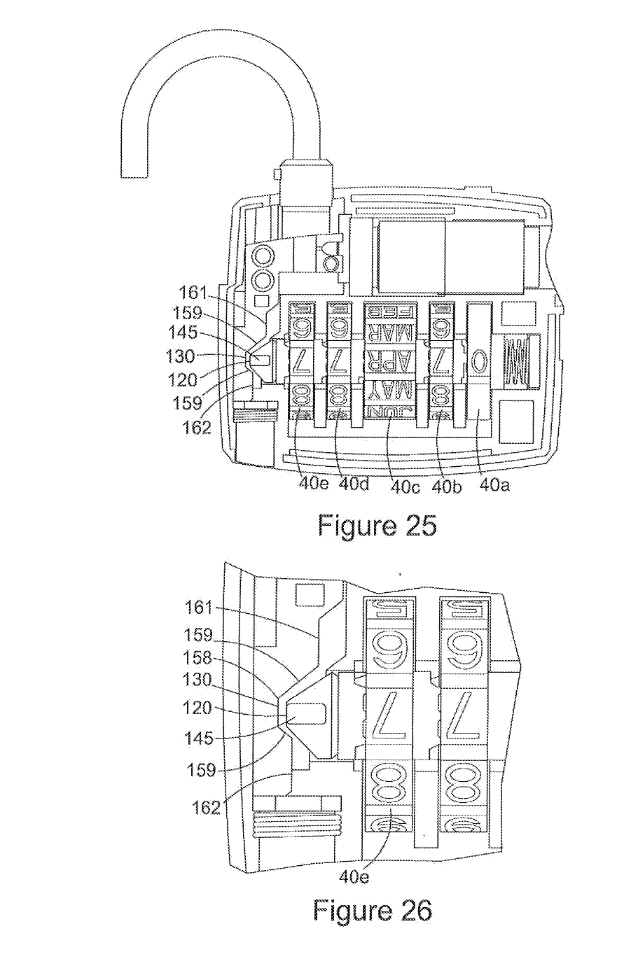

FIGS. 25 to 28 show an alternative lock arrangement, similar to that before, but where the inter-engaging nodule and recess have an alternative shape and structural arrangement, including a separate nodule component with wings for engaging the casing; and

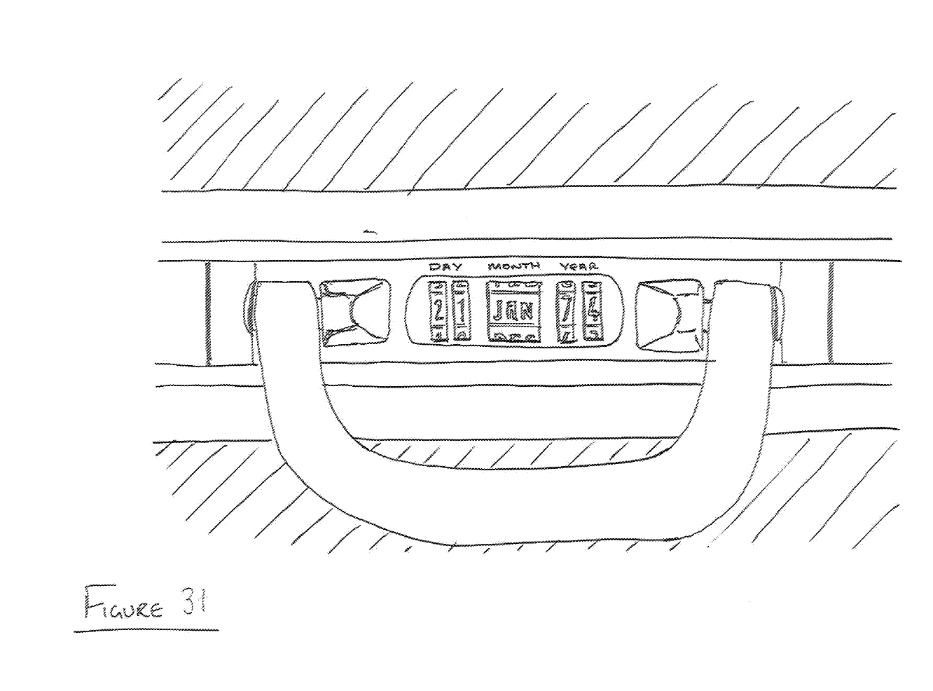

FIGS. 29 to 32 are views of further types of combination lock according to the present invention.

Referring first of all to FIG. 1, there is shown a combination lock 10 of an embodiment according to the present invention. The combination lock 10 comprises a body 20 and a locking member 30. The combination lock 10 also comprises a combination display face 50 located on the front of the body 20. On the side of the body 20 is a TSA general access lock 60 which can be seen in FIG. 3. This is optionally added to offer compatibility with TSA access recommendations in the US since the lock is primarily intended to be a luggage padlock. However, locks of the present invention can also be used for other purposes, whereby the TSA access lock can be omitted if preferred. Its functionality is not the subject of this application, and as such, where provided, it may be of a conventional design.

In the following description, the terms upwards and downwards are used to describe movements of components. Unless stated otherwise, upwards describes a direction from the bottom face of the body 20 (that from which, in this embodiment, the set indicator 90 projects) towards the top of the body 20 (that which, in this embodiment, receives the locking member 30). Downwards describes the opposite direction.

The combination lock 10 of FIG. 1 is in a closed state. The locking member 30 is substantially “U” shaped with a free end 35 of a short leg of the locking member 30 located in a receiving means 70 located on the top of the body 20 (in this embodiment, a collar, but it may be simply a hole in the top of the body, or some other form known from the art). In a locked configuration the locking member 30 is unable to move relative to the body 20, with the locking member free end 35 located within the receiving means 70. In this closed position, the locking member 30 cannot rotate about its other leg—the long leg—since the receiving means prevents it. However, if the padlock is not actually locked, and is instead just pushed closed, (for example by the combination being correct on the input selector), the locking member can still be pulled upward to release the short leg from the receiving means 70, whereupon it then can rotate.

A locking mechanism 80 is located within the body 20. The locking mechanism 80 is responsible for maintaining the lock 10 in a locked state, and also for releasing the locking member 30 so as to allow the padlock to be opened, e.g. when the correct combination is displayed on the combination display face 50. The locking mechanism 80 is also responsible for allowing a user to set or reset the combination required to unlock the device 10 when required.

The locking mechanism 80 comprises an input selector comprising a series of selectable inputs or code component array members, in this embodiment in the form of five rotatable dials 40. A portion of all the rotatable dials 40 is visible at the combination display face 50. An opposing portion is also visible at the back, but that is optional—the back might cover the dials, but having them also visible makes rotating the dials easier.

In the present embodiment the dials 40 are arranged so as to display a date.

In the present embodiment, the first two dials (most leftward when viewing them at the combination display face 50) are used to represent a specific day of a month, ranging from 01 to 31, the centre dial is used to display a month, and in this embodiment (an English language version) this takes the form of the first three letters of the name of the month, and the last two dials (most rightward) represent a year, ranging from 01 to 99.

To reduce the number of blanks or indeterminate or unusable rotation options, or options that would not account for a valid date, the dials do not all have the same number of options on them. For example, the first dial (which displays the ‘tens of days’ only requires the digits 0, 1, 2 and 3. Any other numbers would not be used in a valid date. It is thus designed only to have four “options” printed or marked or engraved or moulded thereon. The second dial instead requires all of the numeral digits (0 to 9) and as such it has ten options on it. The third dial requires 12 options, one for each month: JAN to DEC in this embodiment since it is an English language version. The fourth and fifth dials instead both require 10 options for representing the range of digits 0 to 9.

While this embodiment—typically for the UK market—has the day followed by the month followed by the year, it is to be understood that in further embodiments according to the present invention, the order of the day, month and year within the combination display face 50 may be arranged differently. For example, in the U.S. the preferred order might be such that the month is arranged furthest to the left of the combination display face with the dials representing the day in the middle and the year furthest to the right. Japan may have a further arrangement—year first, and there can even be arrangements with a further or alternative dial, e.g. signifying the zodiac character—e.g. the annual animal of the zodiac for Japan (12 thereof) or the astrological zodiac character (again 12 thereof)—or some other selectable series, such as the days of the week, or colours.

Turning now to FIG. 7, the combination lock 10 can be seen to be in an unlocked, but code-set state. In order to enter the unlocked state the correct combination must be displayed on the combination display face 50. The locking member 30 and its connected components are then, from the state shown in FIG. 1, free to be pulled in an upwards direction (see FIG. 22). The free end 35 of the locking member 30 that was previously located within the receiving means 70 is thus released and the locking member is then free to rotate about the other leg's axis for fully opening the shackle provided by the U shaped locking member.

It will next be described below how the lock 10 is put in a code-set state—a condition in which the locking member 30 is held depressed in a downwards direction relative to the body 20, and in this embodiment with a connecting member 75 located entirely within the body 20, and in this embodiment additionally with a set indicator 90 protruding from the bottom face of the body 20. In this embodiment, in accordance with another aspect of the present invention, the set indicator 90 comprises the word “SET” on its outer surface indicating rapidly to the user that the lock is in a code-set state.

FIG. 11 depicts the lock 10 of FIG. 1 with the front, rear 220 and upper 210 casing removed from the body 20, allowing the locking mechanism 80 to be seen. The lock 10 is in a closed state.

The locking mechanism 80 of this embodiment comprises a cylinder 110 on which the five dials 40 are located. Five clutch sheaths 170 surround the cylinder 110. The cylinder 110 also comprises two end plates, which are used to maintain the clutch sheaths 170 in a condition such that they abut each other. This keeps the degree of play within the lock mechanism to a minimum. Spacing washers may also be added between the elements, however, i.e. it is not essential for them to be touching their adjacent clutch components.

Both the end plates and the central cylinder on which the sheaths 180 are threaded are collectively referred to as the cylinder 110 herein.

The locking mechanism 80 further comprises a connection shaft 100. It is pivotally connected to the connecting member 75 of the locking member 30—a part of the long leg thereof.

The cylinder 110 also comprises a nodule 120 that extends out the end of the cylinder that is located adjacent the connection shaft 100. As shown, this nodule is arranged to abut that connection shaft 100, although an intermediary bearing surface may also be provided. See, for example, FIGS. 25 to 28, discussed further below.

The connection shaft 100 comprises a connection recess 130. The connection recess 130 is in this embodiment a substantially semi-circular indentation in the side of the connection shaft 100 facing the cylinder 110. It preferably has a larger radius than the nodule so that the nodule can extend into it. However, other shapes are also possible. See again, for example, the arrangement in FIGS. 25 to 28.

The nodule preferably has a rounded end for smoothly engaging the internal surface of the connection recess 130 to allow a smooth operation of the lock. One or both of the interfacing surfaces may be rounded. Alternatively, as per the arrangement in FIGS. 25 to 28, they may have other shapes.

In a first arrangement, when in a locked or closed configuration, the nodule 120 is located such that it abuts the inside surface of the connection recess 130 and the cylinder 110 is thus disposed fully rightwards (as seen from the front view of FIG. 11). The connection recess 130 prevents it from further rightwards movement and a spring 140 at the other end of the cylinder biases it in that rightwards direction. It is biased there and thus unable to slide along its axis in the other direction until the connection shaft is moved relative to the nodule.

Note too that the cylinder 110 is also restricted from moving any significant distance perpendicularly to its axis by the surrounding body 20 and dials 40.

When the lock is additionally in a locked configuration, i.e. the combination code is not correctly provided by the dials, the dials and clutch sheaths 170 additionally restrict the movement of the cylinder—the cylinder 110 is locked down such that it is unable to move along its axis. This will be further explained below. However, this then additionally means that the connection shaft 100 is held in place by the cylinder 110 and nodule 120. The locking member 30 is therefore locked down in the body in a locked position by the cylinder when the lock is in a locked configuration.

The set indicator 90 is located below the connection shaft 100 and abuts the lower surface thereof when the lock is in this locked configuration (or a closed configuration or a code-set state). Again an intermediary may instead be positioned between them, but preferably they can contact in this described manner, as illustrated in this embodiment.

The set indicator 90 is connected to a set indicator spring 150 and is biased in an upward, and therefore non-protruding, direction. This thus biases it towards the connection shaft 100. It may be one piece with the connection shaft, but a separate set indicator is preferred to increase the simplicity of assembly.

The spring 150, when these parts are made as separate parts, is useful since it prevents the set indicator from poking out of the casing until the lock is in a code-set state: due to the upward bias, the set indicator 90 is only moved into a protruding position when the connection shaft 100 pushes it downward. This only happens when the lock is put into a code-set state. For that the correct code must first be displayed on the combination display face 50 and the locking member 30 and connection shaft 100 are then able to be moved. To move the set indicator, however, the movement of the connection shaft would need to be downwards into its code-set position for thus forcing the set indicator against the force of the spring, as described in more detail below.

A further feature of the present invention's locking mechanism and body is that it prevents this downward movement of the set indicator from occurring until the locking member has first been rotated into an open state, i.e. rather than just an unlocked and closed state.

Also visible in FIG. 11 is a TSA release cylinder 160. The TSA release cylinder 160 comprises a TSA approved key input face 60 and is used by the transportation security administration (TSA) in the US in the event that the lock needs to be unlocked during transport. This mechanism serves to open the collar 70, thus allowing the locking member to rotate without releasing the combination lock. This is not a part of the invention, and is a conventional, known mechanism. It is not an essential feature of locks of the present invention, and may be omitted completely.

In the present embodiment the locking member 30 is integral with the connecting member 75, both being rotatably connected to the connection shaft 100. In other embodiments, however, the locking member 30 may be a separate component to connecting member 75. Its size is also shown to be bigger (wider) than the short leg and curve of the U shaped part of the locking member 30. This too is optional, but convenient for providing a substantially strong connection for the rotatable connection to the connection shaft—which connection shaft also wants to be adequately strong to resist opening of the lock until the correct combination is applied.

As already mentioned, a spring 140 is located at the opposite end of the cylinder 110, i.e. the end furthest from the connection shaft 100. This spring 140—preferably a coil spring, biases the cylinder 110 in the direction of the connection shaft 100. However, when the lock 10 is an unlocked state, the cylinder can move leftward for compressing the spring. This occurs as the nodule 120 rides out of the connection recess 130 as the connection shaft moves either upwardly or downwardly. Nevertheless, the spring ensures that the nodule 120 is biased against the surface of the connection shaft 240/250.

Upon movement of the locking member 30 into a locking or closed state, the connection shaft 100 is moved back into a position where the connection recess 130 is aligned with the nodule 120, and the nodule 120 thus reverts into the connection recess 130 as the cylinder spring 140 pushes the cylinder rightwards.

FIG. 14 shows the lock 10 in an unlocked and code-set state. In the code-set state the locking member 30, the connecting member 75 and the connection shaft 100 have all been moved in a downwards direction—beyond the position they assume when the lock is in the closed state. In this position the cylinder 110 and the nodule 120 have slid along the axis of the cylinder 110 towards their left (as viewed in FIG. 14) against the bias of the cylinder spring 140. The movement occurs due to the interaction between the nodule 120 and the inner curved surface of the connection recess 130—and the flat 250 above it.

As a result of this full leftwards movement, clutch flanges 180 that are located on the clutch sheaths 170 have disengaged from the dials 40 so as to be exposed into a free space between the dials 40. This is discussed in more detail below, but due to the free space the dials can be freely turned for resetting the lock's unlock code.

The downward motion of the connection shaft 100 has additionally forced the set indicator 90 to move against the bias of the set indicator spring 150 and thus protrude from the bottom of the body 20 of the lock 10.

In the unlocked and code-set state of FIG. 14, the clutch flanges 180 do not engage the dials 40, and as a result the dials are free to rotate without affecting the position or orientation of the clutch sheaths 170. That rotation will thus reset the unlock code, whereas movements of the dial while the clutch flanges engage the dials—the usual non-code-setting state—would rotate the clutch sheaths with the dials, thus mis-aligning the clutch flanges relative to one-another, and thus locking the lock—the flanges need to be aligned both with respect to each other, and the lock body 20 for the cylinder 110 to move along its axis through the dials, as explained below.

The set indicator 90 is also maintained in a protruding position, during the code-set state, until the connection shaft 100 returns to an upward or default (locked state or lock closed state) position.

FIG. 16 is a bottom view of the arrangement of FIG. 14 and illustrates that the clutch flanges 180 are disengaged from the dials 40—in the spaces between them—and that they are also all linearly aligned and located in a given orientation relative to the cylinder's central shaft since otherwise their axial movement is resisted e.g. by the form of the casing, as is known in the art, and as is shown in FIG. 20 by the flanges and cut-outs 230 therein. This is described more specifically further down below. However, through this arrangement, only when the clutch flanges are in this alignment is the cylinder able to move through the dials: as can be seen in FIG. 19, a side view of a typical dial 40 for a ten option version, the inner surface of the dial 40 comprises a series of recesses or crenellations (ten thereof to match the number of indicia on the dial—for the month dial there would be 12, etc.) and only when a crenellation on each dial is aligning with the clutch flanges 180 at the same time that the clutch flanges are themselves aligned in the correct orientation—here downwardly, can the cylinder 110 move through the dials.

The crenellations in this embodiment form a series of semi-circular cut outs, the profile of these cut outs matching, or being only slightly larger than, that of the clutch flanges 180. This is to reduce any play in the lock to an acceptable level—play can allow a code to be broken by dextrous fingertip feedback. Shapes other than semi-circles, such as squares, triangles or rectangles, are also useable. Curved sided shapes can also be used.

When the cylinder 110 and clutch sheaths 170 are in their locked positions, i.e. slid to the right, with the nodule 120 mated with the connection recess 130, the clutch flanges 180 mate with the crenellated surface of the inside of each of the dials 40. This ensures that the dials 40 are unable to rotate independently of the clutch sheaths 170.

FIG. 17 illustrates the lock 10 in a locked configuration with all of the casing as well as the dials 40 removed. This, along with FIGS. 18 and 19, further help to illustrate this clutch/code setting feature.

The clutch sheaths 170 can be seen, threaded on the cylinder 110. Each clutch sheath 170 is tubular and comprises a clutch flange 180, the clutch flanges 180 in this embodiment being partial cylinders protruding from the surface of the sheaths 170, aligned with the axis of the cylinder 110, and hence being hemi-spherical in shape, as discussed above for the crenellations.

Turning now to FIGS. 21 to 24, the method by which the lock 10 enters the code setting state will be described.

FIG. 21 shows the lock 10 in a closed state. A restraining protrusion 190 can be seen on the connecting member 75. In the closed state the restraining protrusion 190 is located externally of the body upper casing 210, although it might be lowered into the upper casing since a slot 202 is provided therefore—see FIG. 24. When the correct code is present at the combination display face 50 the cylinder 110 is free to move along its axis against the biasing force of the cylinder spring 140. As such, the connection shaft is free to move in an upwards direction. As the connection shaft 100 and hence locking member 30 move upwards—to the position shown in FIG. 22—the locking member's free end 35 disengages from the restraining means 70 and the locking member is hence free to rotate with respect to the body 20 of the lock 10 about the axis of the connecting member, thus swinging the free end 35 away from the restraining means 70.

FIG. 24 illustrates a code set slot 200 extending perpendicularly to the locked-position of the locking member 30 (and the slot 202). When unlocked, the locking member 30 can be pulled out to free the free end, as already described, and as shown in FIG. 22, and then it can be rotated 90° thus aligning the restraining protrusion 190 with the code set slot 200. Other angles are possible, but the position of this code set slot provides a predetermined angle—here 90°.

Once aligned, the locking member 30 can be pushed back inwardly towards the body 20. The restraining protrusion 190 enters the code set slot 200 and the locking member 30, connecting member 75 and connection shaft 100 are slid as a single unit downwards in a direction towards the set indicator 90. This results in the connection shaft 100 being in the position shown in FIG. 23, with the set indicator thus then being engaged and pushed to extend out of the bottom of the body 20.

Once the locking member 30 is fully depressed, the restraining protrusion 190 is located below the body upper casing 210 and will be able to enter a groove 204 provided thereunder which circumscribes around a part of the perimeter of the area of the body surrounding the connecting member. See FIGS. 21 and 23. The locking member 30 is thus again free to rotate, here in a clockwise direction, to the final code-set state shown in FIG. 23. This is a rotation of a further 90° in this embodiment so as to provide a total rotation of 180°, although again other angles are possible. Although we describe herein that the lock 10 is in a code-set state once the locking member 30 has been rotated a further 90°, the unlock-combination can in fact be reset at any point once the locking member 30 has been depressed with the nodule 120 resting against upper connection shaft surface 250. It is preferable, however, that the user fully rotate the locking member 30 the second 90° (for the present embodiment) to ensure the locking member 30 does not accidentally exit a depressed state due to the bias of the set indicator spring 150. This is achieved since the protrusion 190 is retained in a channel and can only escape therefrom through the provided slot 200. The code-set state, however, is to be taken to be arrived at in the preferred embodiment, however, at a predetermined point of rotation after the initial depression, e.g. after a further rotation of 10 degrees or more.

In the code-set state the restraining protrusion 190 is located and restrained by the body upper casing 210. This prevents the locking member 30, connecting member 75 and connection shaft 100 from moving in a direction away from the set indicator 90 under the bias of the spring 150 that can otherwise resist the depression of the locking member.

The further rotated configuration is known as the code-set state in which a new input code can be selected.

Referring now back to FIG. 20 there is illustrated the interaction between the dials 40, the clutch sheaths 170, the clutch flanges 180, the cylinder 110 and the body casing—here shown is just the rear casing 220.

It can be seen that the dials 40 are unable to move along the axis of the cylinder 110 because they are restrained by the body casing 220. The cylinder 110 therefore is only able to move along its axis when the clutch sheaths 170 are free to slide relative to the body rear casing 220 and the body front casing—shown in FIG. 1.

As the clutch sheaths 170 are aligned along the length of the cylinder abutting each other and are held in place by two disks at either end of the cylinder 110, the cylinder 110 is also unable to move parallel to its axis relative to the clutch sheaths 170.

It can be seen in FIG. 20 that the flanges 206 of the body rear casing 220 which hold the dials 40 in place each comprise a quarter-circular cut out 230. This shape is to match that of the clutch flanges, although other shapes are possible, as with the crenellations and clutch flanges themselves. When the rear casing 22 is mated with the body front casing (which has opposing quarter-circular cut outs in similar flanges—not shown) these quarter-circular cut outs 230 form semi-circular cut outs located at the lowermost positions of resulting circular holes through the mating flanges (now walls), through which the clutch sheaths 170 pass. These cut outs 230 therefore restrict motion of the clutch sheaths 170 when the clutch flanges 180 are not aligned with the semi-circular cut outs 230, which in turn prevents the cylinder 110 from moving along its axis. When all the clutch sheaths are in the correct orientation as a result of the correct code being displayed on the combination display face 50, the clutch flanges are in alignment with those cut outs 230 and that allows the cylinder to be moved. As such, the connection shaft 100 and consequently locking member 30 are unable to move into an unlocked position until that occurs, whereby the locking member 30 is prevented from being disengaged from the receiving means 70 until the correct code is displayed on the combination display face 50.

Once the correct code is displayed on the combination display face 50, all the clutch sheaths 170 are correctly orientated, i.e. the clutch flanges 180, in this embodiment, are located at a lowermost position and are aligned with the semi-circular cut out 230 located in the body rear casing 220. The combined unit of the cylinder 110 and clutch sheaths 170 is then free to slide along the axis of the cylinder 110 towards the cylinder spring 140.

The sliding movement is actuated when a user, attempting to unlock the padlock 10, asserts a force on the locking member 30 to pull it up, and therefore also to pull up the connection shaft 100, in turn forcing the cylinder 110 and clutch sheaths 170 against the biasing force of the cylinder spring 140 due to the interaction of the nodule 120 and the connection recess 130 (although due to the reduced “height” of the lower flat surface 240 (see FIG. 23) compared to the upper flat surface 250 in a direction parallel to the axis of the cylinder 110), the movement is insufficient to attain the code-set state).

When in an unlocked and open state, but not in the code set state, the locking member 30 is disengaged from the receiving means 70 and the connection shaft 100 is displaced in an upwards direction, i.e. away from the set indicator 90.

In this configuration, the tip of the nodule 120 rests against a lower connection shaft surface 240, this surface being a flat surface facing the cylinder 110, located on the side of the connection recess 130 nearest the set indicator 90. This surface can be seen in FIG. 14 as well, although this figure does not show the lock 10 in this state.

Lower connection shaft surface 240 is located further away from cylinder spring 140 than the equivalent surface 250 on the upper side of the connection recess 130 due to its reduced height mentioned above. As such, when the lock 10 is in an unlocked and open state, but not in a code set state, the cylinder 110 and the clutch sheaths 170 are not displaced far enough in the direction of the cylinder spring 140 to entirely disengage the clutch flanges 180 from the internal crenellations of the dials 40. As such, the dials 40 are unable to rotate relative to the clutch sheaths 170. Additionally, the clutch sheaths 170 are unable to rotate relative to the body rear casing 220 as a portion of the clutch flanges 180 are located within the body rear casing cut outs 230. This means that when the lock 10 is in an unlocked and open state but not in a code-set state, the dials 40 cannot be changed from the correct combination.

If, once the lock 10 is unlocked and open, the user decides they would like to change the combination to unlock the lock 10, the lock 10 must be put in the code-set state. This is done, as described above, by rotating the locking member 30 so that the restraining portion 190 is aligned with the code set slot 200 and depressing the locking member 30, and therefore connection shaft 100, and rotating the locking member a further 90° in the clockwise direction as viewed in FIG. 24. The lock 10 and locking mechanism 80 will then be in the state illustrated in FIG. 14.

In this configuration, the nodule 120 rests against an upper connection shaft surface 250 located above the connection recess 130, furthest away from the set indicator 90. It can be seen that the internal profile of the connection shaft 100 is such that the upper connection shaft surface 250 forces the cylinder 110 and clutch sheaths 170 further towards the cylinder spring 140 than the lower connection shaft surface 240. In the lock set state the clutch flanges 180 are fully disengaged from the dials 40 and, as explained above, the dials 40 are free to rotate independently of the clutch sheaths and flanges 170, 180.

During the process of taking the lock 10 out of the code-set state, the locking member 30 is rotated 90° in an anti-clockwise direction as viewed in FIG. 24, so that the restraining protrusion 190 is again aligned with the code set slot 200, this allows the locking member 30 to again extend away from the lock body 20—it will spring out under the bias of the cylinder's spring—so that the restraining protrusion 190 is no longer constrained by the body upper casing 210, and the nodule 120 and connection recess 130 again mate as the cylinder 110 and clutch sheaths 170 are actuated towards the connection shaft 100 by the cylinder spring 140. During this process, each clutch flange 180 mates with a crenellation on the inside of a dial 40 thus again preventing the dials 40 from rotating independently of the clutch sheaths 170, thus locking the newly chosen combination into the input selector (the dials).

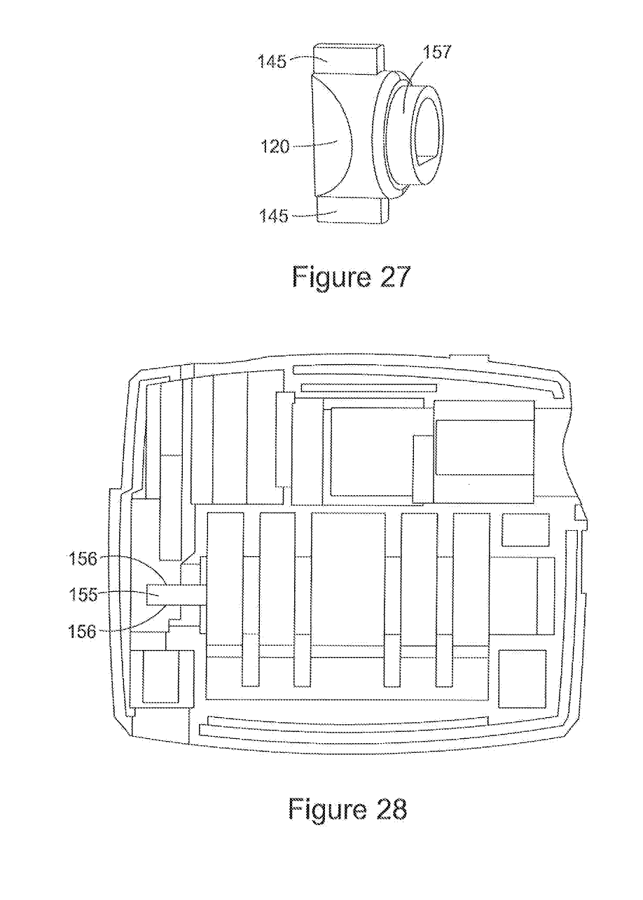

Referring next to FIGS. 25 to 28, a slightly different arrangement for the internal mechanism is shown compared to that of the previous embodiment. It still functions in much the same way. However, in place of the rounded nodule 120, a separate, and less rounded nodule 120 is provided. FIG. 27 clearly shows this nodule 120 to be a separable piece of the cylinder 110—it is fabricated as a separate piece and can be fitted to the recess 130 facing end of the cylinder 110, to the left of the set of dials 40 as shown in FIG. 25. It functions in the same manner as the earlier nodule 120 (e.g. for engaging the recess 130, and for controlling the mode of the lock). However, the arrangement of the inter-engaging surfaces of the nodule 120 and the recess 130 are differently shaped.

The shape of this alternative nodule 120, although different, still has a recess engaging face, but this face is now less rounded—in the illustrated embodiment it is more square faced, but with chamfered and rounded edges and corners, rather than the previous semi-circular/semi-spherical shape. It is also more flat in the transverse direction than before—whereas before it was almost semi-spherical, and thus curved similarly in all directions, it is now of a generally constant transverse section in the planes transverse to the recess 130 so as to provide a larger area of contact against that recess 130. This reduces wear and it also reduces lateral “wobble”—the free end of the nodule 120 will bear against the recess 130 along a line of contact rather than perhaps at only a single point of contact.

The nodule 120 additionally now has an optional but preferred pair of wings 145 extending from lateral sides thereof. These wings 145—two in this illustrated embodiment, although only 1 or more than 1 might be provided instead—are for engaging within a groove 155, or against one or more flange 156, in the casing, and can provide additional stability for the lock-set mechanism since the nodule 120 is now also held by the casing, rather than just by the cylinder and dials. It is also helpful given that the nodule 120 is now a separate component to the cylinder 110, whereby it does not get stabilised by a long length thereof extending through the dials 40. Instead, in this illustrated embodiment, only a short length 157 is engaged within the dials 40 or against the cylinder 110. That length 157 may be changed, either longer or shorter, compared to that shown, as would be apparent to a skilled person, given the shape and configuration of the cylinder 110 and dials 40.

The wings 145 have a generally rectangular cross section in this embodiment, and that gives good stability within the grooves 155. However, other shapes are also possible, although an elongate shape is preferred for the stability it provides. Note though that multiple wings or flanges may instead be provided to achieve adequate stability.

The shape of the recess 130 in this embodiment has also been changed—rather than being generally rounded, and of a larger radius than the rounded nodule 120, it now has an angular shape, with a flat middle face 158—defining a plane that preferably lies perpendicular to the rotation axis of the dials 40 (or the longitudinal axis of the nodule 120), and two ramps 159 at the ends thereof, one for extending to the surface 161 engaged by the nodule 120 when the lock is in the set state, and the other extending to the surface 162 engaged by the nodule 120 when the lock is in the open state.

In this preferred arrangement of FIGS. 25 to 28, the lower ramp 159 is the shorter of the two.

Preferably, as per the illustration, the ramps 159 and the flat middle face 158 are blended together at their intersections so as to allow a smooth operation of the sliding action between the nodule 120 and the recess 130. This blending may match any blending between the end and chamfers of the nodule 120, but that is not essential.

In the illustrated arrangement, the chamfers of the nodule 120 are angled to approximately match the angles of the ramps 159. It should be noted, however, that differing angles, or fully curved surfaces as with the previous embodiment, may instead be provided.

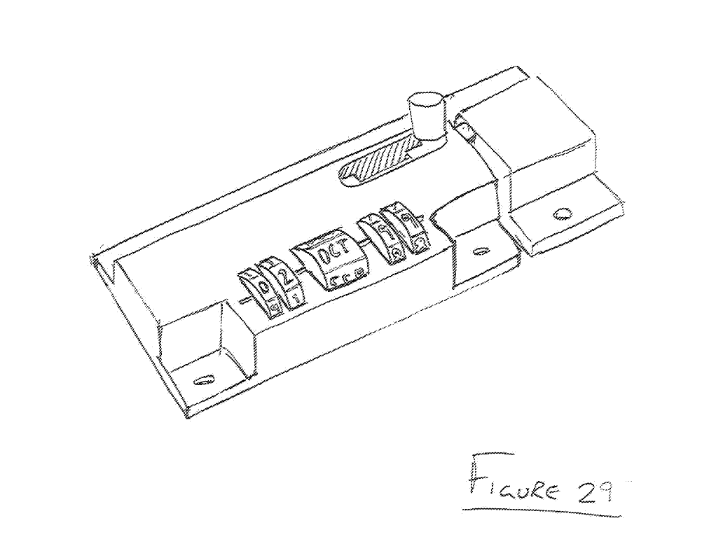

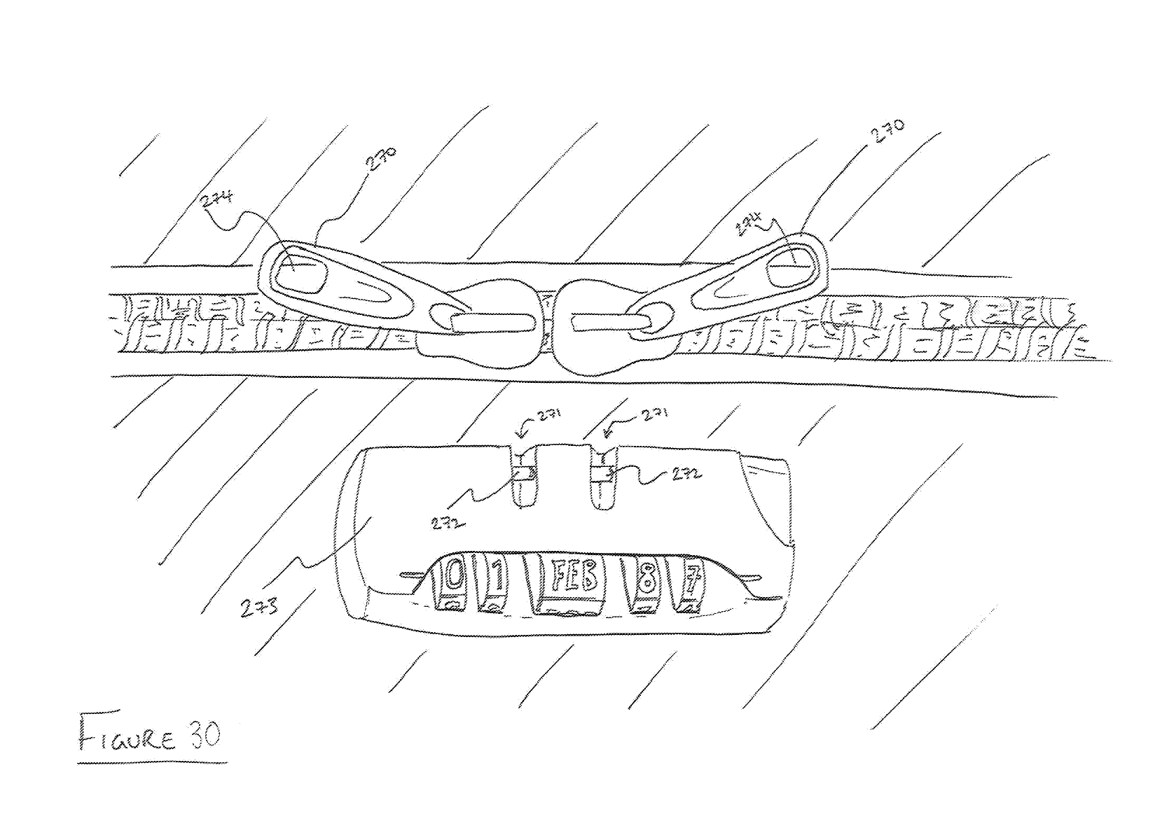

Referring next to FIG. 28, the inside of one side of the casing or housing is shown. From this it can be seen that there are grooves in which the dials can rotate. Further, a groove 155 for one of the wings 145 of the nodule 120 can be seen. This groove 155, in this embodiment, is perpendicular to the grooves for the dials, and is formed by two flanges 156.

FIG. 29 then shows a bolt lock, or shoot bolt according to some embodiments of the present invention. It has incorporated therein a combination release mechanism that utilises the features of the present invention, i.e., for example, the date-arrangement for the dials, that release mechanism replacing a conventional three or four, equally sized and shaped, combination dial release mechanism.

FIG. 30 then shows a zipper lock according to the present invention. When in a locked configuration, the zip handles 270 are each located within a recess 271. The locking member 272, located entirely within the boundary of the body 273, slides through the holes 274 to lock the zip handles 270 within the body 273.

In this embodiment, the body 273 is the lock casing and it defines a space therein bounded at its base by a top surface of the shell of the suitcase.

As in the embodiment of FIG. 29, it has incorporated therein a combination release mechanism that utilises the features of the present invention, i.e., for example, the date-arrangement for the dials, that release mechanism replacing a conventional three or four, equally sized and shaped, combination dial release mechanism.

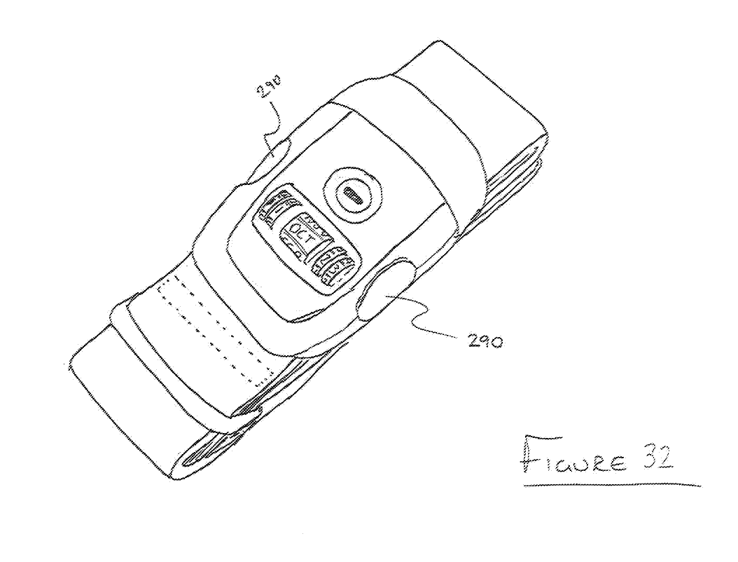

FIG. 31 shows an integrated suitcase or briefcase lock, also known as a panel lock. As in the embodiment of FIG. 29, it has incorporated therein a combination release mechanism that utilises the features of the present invention, i.e., for example, the date-arrangement for the dials, that release mechanism replacing a conventional three or four, equally sized and shaped, combination dial release mechanism.

The suitcase (or it could be a briefcase) of FIG. 31 can only be opened once the correct date is displayed on the display face.

In the embodiment of FIG. 31, the body is a part of the suitcase—it is integrated into one of the interengaging frames that edge the suitcase' upper and lower shells.

FIG. 32 shows an example of a luggage strap incorporating a combination lock according to the present invention. The buckle of this luggage strap comprises the body, and in this illustrated example the buckle further comprises a TSA approved key slot.

In this arrangement, the locking member is entirely concealed within the body, and may comprise a rotating, sliding, or flexing blocking bar. When in a locked position, the locking member is in a position so as to block the inward-movement of the two buckle-buttons 290, as known in conventional combination locked luggage straps. As such, the buckle-buttons 290 cannot be compressed, and the buckle cannot be undone. Once the correct date is present on the combination display face, the locking member is no longer in the path of movement of the buckle-buttons 290, and the buckle-buttons are free to move within the buckle, allowing it to be undone in a similar fashion to a standard buckle.

The operation of the locking mechanism in locking and unlocking the locking member may be largely standard, as would be apparent to a skilled reader.

The various aspects of the present invention have therefore been described by way of an exemplary embodiment. It will be appreciated, however, that the various aspects of the present invention are not intended to be limited to the above specific embodiment only. Many variants will be readily apparent to one of ordinary skill in the art without departing from the scope of the appended claims.

1. A combination lock comprising:
a body;
a locking mechanism comprising at least one input selector, the or each input selector comprising a plurality of code component array members in the form of cylindrical dials that can be interacted with by a user to rotate them to select for each code component array member thereof a code component from a plurality of possible code component options such that a code combination can be selected and such that the selected code can be displayed at the combination display face; and
a locking member that is selectively lockable by the locking mechanism, wherein:
at least one of the cylindrical dials defines as its code component options a plurality of selectable numbers;
at least one of the cylindrical dials defines as its code component options a plurality of selectable letters;
at least one of the cylindrical dials has exactly four options;
at least one of the cylindrical dials has exactly ten options;
at least one of the cylindrical dials has exactly twelve options; and
the cylindrical dials are aligned within the body, and arranged to rotate about an axis running through the center of the generally cylindrical form that is formed thereby, the combination display face and the dials thus being arranged for displaying the variable combination code in a date format.

2-10. (canceled)

11. The combination lock of claim 1 wherein at least one of the cylindrical dials has exactly 7 options.

12-13. (canceled)

14. The combination lock of claim 1 wherein the combination lock additionally comprises a key-lock mechanism.

15. The combination lock of claim 1, wherein the locking member is a curved metal loop protruding from one face of the body.

16-17. (canceled)

18. The combination lock of claim 1 wherein the locking mechanism further comprises a code set indicator that is exposed when the combination lock is in a code-set state.

19. The lock of claim 18, wherein the code set indicator displays a word or symbol to illustrate the code-set state or mode is operative.

20. The lock of claim 19, wherein the code set indicator displays the word “SET”.

21. The combination lock of claim 1 wherein at least one cylindrical dial has at least one selectable option in which there is more than one character.

22-26. (canceled)

27. The combination lock of claim 18, wherein the indicator protrudes from the body when exposed.

28-33. (canceled)

34. The combination lock of claim 24, wherein an image, symbol, or word is etched, engraved, or embossed in or on the indicator.

35. (canceled)

36. The combination lock of claim 1, wherein a required sequence of movements is required to enter the code-setting state, that sequence comprising a step in which the locking member must be simultaneously pushed towards the body and rotated.

37-38. (canceled)

39. The combination lock of claim 1, wherein the body is a buckle or a part thereof.

40. The combination lock of claim 1, wherein the body is a suitcase or a part thereof.

41. The combination lock of claim 1, wherein the locking member is located entirely within the body.

42-59. (canceled)

60. The combination lock of claim 18, wherein the code-set state is achieved by a movement of the locking member and the code set indicator that will be exposed when the combination lock is in a code-set state displays an image, symbol or word thereon to illustrate and advise that the code-set state is operative.

61. A combination lock comprising:
a body;
a locking member;
a combination display face; and
a locking mechanism comprising at least one input selector, the or each input selector comprising a plurality of selectable inputs, each having a plurality of code component options thereon, the or each input selector being arranged to be interacted with by a user for enabling the user to select a code therewith, the code being indicated by selected code component options on the selectable inputs, the selected code being displayed on the combination display face, wherein:
some of the selectable inputs do not have the same number of selectable code component options thereon to the other selectable input or inputs;
at least one selectable input has exactly four options;
at least one selectable input has exactly ten options;
at least one selectable input has exactly twelve options;
the combination display face is arranged for displaying from the selectable inputs a variable combination code comprised of the selected code in a date format; and
the selectable inputs are cylindrical wheels or dials that are aligned within the body for rotation to select a selected code for display on the combination display face, the cylindrical wheels or dials being arranged to rotate about an axis running through the center of the generally cylindrical form that is formed by the cylindrical wheels or dials.

62. A combination lock comprising:
a body;
a combination display face for displaying a variable combination code;
a code set indicator that will be exposed when the combination lock is in a code-set state;
a locking mechanism comprising at least one input selector, the or each input selector comprising a plurality of wheels that can be interacted with by a user to select for each code component array member thereof a code component from a plurality of possible code component options such that a combination code can be selected and such that the selected combination code can be displayed at the combination display face; and
a locking member that is selectively lockable by the locking mechanism, wherein:
the wheels are cylindrical and aligned within the body, and are arranged to rotate about an axis running through the center of the generally cylindrical form that is formed by the wheels to select the selected combination code for display on the combination display face; and
the code-set state is achievable by a movement of the locking member, the code set indicator then being exposed to display an image, symbol or word thereon to illustrate and advise that the code-set state is operative.

63. The combination lock of claim 62, wherein the movement of the locking member and the exposure of the code set indicator comprises a sequence of movements of the locking member involving a step in which the locking member must be simultaneously pushed towards the body and rotated.

64. The combination lock of claim 62, wherein at least one of the wheels has exactly four options, at least one of the wheels has exactly ten options, and at least one of the wheels has exactly twelve options.

65. The combination lock of claim 64, wherein the combination display face and wheels are arranged for displaying the selected code in a date format.
